(19) United States
(12) Patent Application Publication
(10) Pub. No.: US 2018/0069765 A1
(43) Pub. Date: Mar. 8, 2018

(54) DISPLAYING DATA OF A DATA PROCESSING SYSTEM

(71) Applicant: Amit Verma, Erlangen (DE)

(72) Inventor: Amit Verma, Erlangen (DE)

(21) Appl. No.: 15/695,592

(22) Filed: Sep. 5, 2017

(30) Foreign Application Priority Data
Sep. 6, 2016 (EP) 16187356.7
Jun. 21, 2017 (EP) 17177121.5

(51) Int. Cl. H04L 12/24; G06T 11/20

(52) U.S. Cl. CPC H04L 41/22; H04L 67/12; G06T 2200/24; G06T 11/206

(57) ABSTRACT

A graphical data priority representation for visualization and control of data processing in data processing systems such as industrial Internet of things systems is provided.

This application claims the benefit of EP 16187356.7, filed on Sep. 6, 2016, and EP 17177121.5, filed on Jun. 21, 2017, which are hereby incorporated by reference in their entirety.

### BACKGROUND

The present embodiments relate to data processing in device networks.

The “Internet of Things” (IoT) is a name for a known trend in information technology that refers to various technologies and methods for devices to exchange data via the Internet and other computer networks.

These concepts are useful in industry, including industrial automation systems, machines, sensors, etc. The “Industrial Internet of Things” (IIoT) refers generally to the collection of data from data nodes, monitoring the performance of associated devices based on the collected data, and usually managing or adjusting the control of the devices based on the collected data. An IoT architecture may be “industrial” by virtue of the types of devices that are connected, by the choice of communications protocols that are used to exchange data, by the choice of network architecture that is employed, or by physical characteristics of the devices and network components such as being able to cope with wide variations in temperature or being robust to cope with vibrations or other harsh environmental conditions.

A data node is anything that generates data samples and may, for example, include a device, a controller, a sensor, or a machine, or a collection of devices, controllers, sensors or machines.

IoT and other similar networks of devices or other data nodes tend to generate a lot of data. This places demands on network infrastructure that connects the devices together and with remote platforms for monitoring and managing the devices. Because of this, it is desired to control the flow of data across the network. One way of controlling the data flow is to make a distinction between data that has a relatively high priority as compared to data that has a relatively low priority, with processing of the high priority data being preferred over the low priority data.

However, it is difficult for users such as network managers or platform operators to clearly and quickly ascertain which data has which priority levels, and to make any required adjustments.

### SUMMARY AND DESCRIPTION

The scope of the present invention is defined solely by the appended claims and is not affected to any degree by the statements within this summary.

There is a need to prioritize the industrial data in a granular manner, but assigning priorities to the various types of industrial data may be difficult to understand, visualize, and realize clearly. Prior art computer user interfaces do not provide for granular control of data priorities. The present embodiments may obviate one or more of the drawbacks or limitations in the related art. According to a first aspect, a method of displaying data of a data processing system is provided. The data processing system includes a plurality of data nodes configured to provide data samples. The method includes generating a graphical data priority representation. The generating of the graphical data priority representation includes displaying, in a first display dimension, a first list with members representing the data samples or data sample categories. Each member of the first list has an associated priority level. The generating of the graphical data priority representation also includes displaying, in a second display dimension, a second list with members including data sample sub-types or further data sample categories. Each member of the second list has an associated priority level. Each display dimension is ordered according to data priority levels associated with each list member. The generating of the graphical data priority representation includes displaying a priority boundary demarcating different portions of the graphical data priority representation that are associated with different priority levels.

The first list is constituted with respect to, for example, the origin of the data samples and/or the type of data included in the data samples (e.g., with respect to a data type or a data category). The data samples stemming from the data nodes may include data referring to alarms and/or events occurring in the data processing system or the relevant manufacturing plant. The data samples stemming from the data nodes may include time series data (e.g., temperature data, pressure data etc.). Further, the data samples stemming from the data nodes may include log file data. The second list is constituted with respect to a further data type (e.g., data sample sub-type) or a further data category. Data samples referring to alarms and/or events occurring in the data processing system or the relevant manufacturing plant may include data referring to errors and/or warnings. Errors and warnings are data sample sub-types or further data sample categories. Time series data may include data obtained with a first sampling rate and a second sampling rate. The relevant sampling rate is a further example for a data sample sub-type or a further data sample category. The aforementioned is a simplified example only aimed at facilitating an easy and general comprehension of the present disclosure and is not to be construed as limiting.

This method allows for an intuitive and easy to understand way to visualize the data priorities that have been applied in a data processing system. The method allows for quick decisions to be made regarding how to change the operation of a system upon occurrence of various events such as degradation of health of a device network.

Optionally, each member of the first list represents a group of data samples, each group being provided by one or more data nodes.

Optionally, one or more of the members of the first list represents a data sample type.

Sorting by data type provides that data samples of similar utility or relating to similar functionality may be easily grouped together.

Optionally, the graphical data priority representation includes one or more further display dimensions based on further characteristics of the data samples from the data nodes.

This allows for three-dimensional or higher-dimensional graphical data priority representations to be plotted, providing rich visualizations of complex data sets.

According to a second aspect of the disclosure, a method of defining priorities for data processing in a data processing system is provided. The method includes displaying data according to the method of the first aspect and re-drawing the priority boundary on the graphical data priority representation to change the data priority levels associated with members of one or more of the lists.

The display of the first aspect may be interactive so that the priorities for different data samples may be adjusted. The use of a simple graphical object, the priority boundary, makes this easy and intuitive to achieve.

Optionally, re-drawing the priority boundary is performed by a user via a user interface.

According to a third aspect of the disclosure, a method of controlling data processing in a data processing system is provided. The method includes defining data priority levels for data processing according to the second aspect, and processing the data according to the defined priority levels.

Optionally, processing the data according to priority levels includes one or more of: i. collecting selected data from the data nodes; ii. transmitting selected data from the data nodes to a remote platform; iii. storing selected data at a remote platform; and iv. analyzing selected data at a remote platform. The data is selected according to the data priority levels.

Optionally, the selection of data according to the data priority levels includes selecting data in order of the priority levels from a highest priority level to a lowest priority level.

According to a fourth aspect of the disclosure, a data processing system includes a plurality of data nodes configured to provide data samples, and one or more processors configured to generate a graphical data priority representation. The generation of the graphical data priority representation includes display, in a first display dimension, of a first list with members representing the data samples. Each member of the first list has an associated priority level. The generation of the graphical data priority representation includes display, in a second display dimension, of a second list with members including data sample sub-types. Each member of the second list has an associated priority level. Each display dimension is ordered according to data priority levels associated with each list member. The generation of the graphical data priority representation includes display of a priority boundary demarcating different portions of the graphical data priority representation that are associated with different priority levels.

According to a fifth aspect of the disclosure, a computer program product including instructions that, when executed by a computing device, enable the computing device to generate a graphical data priority representation for data samples provided by a plurality of data nodes in a data processing system is provided. Generating the graphical data priority representation includes displaying, in a first display dimension, a first list with members representing the data samples. Each member of the first list has an associated priority level. Generating the graphical data priority representation also includes displaying, in a second display dimension, a second list with members including data sample sub-types. Each member of the second list has an associated priority level. Each display dimension is ordered according to data priority levels associated with each list member. Generating the graphical data priority representation includes displaying a priority boundary demarcating different portions of the graphical data priority representation that are associated with different priority levels.

The computer program product may be stored on or transmitted as one or more instructions or code on a computer-readable medium (e.g., a non-transitory computer-readable storage medium). Computer-readable media includes both computer storage media and communication media including any medium that facilitates transfer of a computer program from one place to another. A storage media may be any available media that may be accessed by a computer. By way of example, such computer-readable media may include RAM, ROM, EEPROM, CD-ROM or other optical disk storage, magnetic disk storage or other magnetic storage devices, or any other medium that may be used to carry or store desired program code in the form of instructions or data structures and may be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infra-red, radio, and microwave, then the coaxial cable, fiber optic cable, twisted pair, DSL, or wireless technologies such as infra-red, radio, and microwave are included in the definition of medium. Disk and disc, as used herein, includes compact disc (CD), laser disc, optical disc, digital versatile disc (DVD), floppy disk, and blu-ray disc, where disks usually reproduce data magnetically, while discs reproduce data optically with lasers. Combinations of the above are also included within the scope of computer-readable media. The instructions or code associated with a computer-readable medium of the computer program product may be executed by a computer (e.g., by one or more processors, such as one or more digital signal processors (DSPs), general purpose microprocessors, ASICs, FPGAs, or other equivalent integrated or discrete logic circuitry).

### BRIEF DESCRIPTION OF THE DRAWINGS

The shown embodiments are intended to illustrate, not limit, the invention. The drawings contain the following figures, in which like numbers refer to like parts throughout the description and drawings and wherein:

FIG. 1 shows one embodiment of a data processing system;

FIG. 2 shows an embodiment of a graphical data priority representation that may be used with the data processing system of FIG. 1; and

FIG. 3 shows aspects of a possible implementation for a graphical data priority representation.

### DETAILED DESCRIPTION

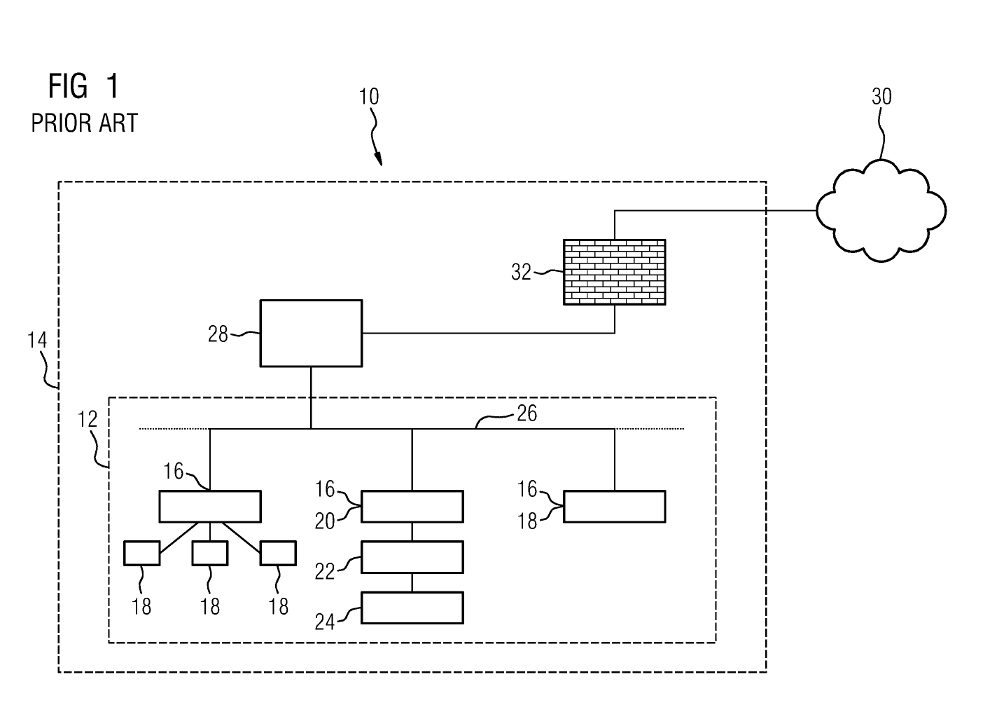

FIG. 1 shows one embodiment of a data processing system 10 (e.g., a “system” 10). The data processing system 10 may be an IoT system. In the example of FIG. 1, a device network 12 is provided at a manufacturing plant 14. The device network 12 includes a plurality of data nodes 16. Any number of data nodes 16 may be provided (e.g., from a single node up to many millions or more); but for the purpose of illustration, however, three exemplar types of data node 16 are shown.

One type of data node 16 includes a collection of sensors 18, each providing corresponding data samples. Another type of data node 16 includes a controller 20, such as a programmable logic controller (PLC), that provides data samples gathered from machinery such as a drive 22 and a motor 24. Another type of data node 16 includes a sensor 18. The sensor 18 in this type of data node 16 does not need to be associated with any specific (e.g., industrial) device. The sensor 18 may be used to monitor other aspects such as ambient temperature or humidity and so on. Many other types of data nodes that are not illustrated in FIG. 1 may be provided.

The data processing system 10 includes network infrastructure including a communications bus 26 that may be coupled with the data nodes 16. The data nodes 16 may communicate data samples via field protocols such as PROFINET, PROFIBUS, Industrial Ethernet, EtherCAT, and so on.

The device network 12 is connected to a gateway 28 that acts to exchange data between the device network 12 and a remote platform 30 (e.g., via a firewall 32). The gateway 28 may include a switching device and various other components to receive data from the device network 12 and send the data on to the remote platform 30 for processing, reporting, and analysis. The remote platform 30 may provide a cloud service for carrying out these functions.

The remote platform 30 may then send instructions back to the gateway 28 for adjusting the operation of the device network 12. The gateway 28 relays the instructions via the network infrastructure to the connected devices to adjust operational parameters of the connected devices.

This is one example of a data processing system 10 to which the present disclosure may be applied.

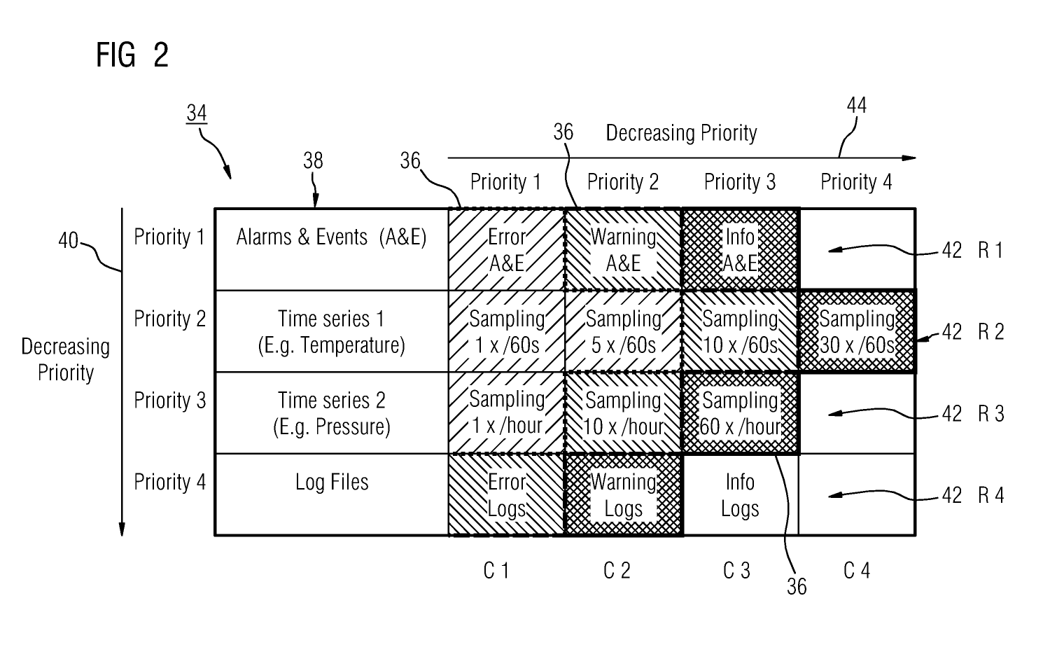

As shown in the non-limiting and specific example of FIG. 2, the present disclosure provides a graphical data priority representation 34 (e.g., data priority map) that may be used to visualize priorities for data that is to be processed in a data processing system 10. The graphical data priority representation 34 includes the grid that is shown. The other annotations in the figure are for purposes of illustration only, although in alternative embodiments data such as priority levels or row/column indices may be displayed. The graphical data priority representation 34 also includes one or more priority boundaries 36 that are used to demarcate different portions of the graphical data priority representation 34 that are associated with different priority levels.

In one embodiment, a user interface may be provided to define priorities for data processing. The user interface may suitably provide a way (e.g., a device) for interacting with displayed priority boundaries 36 to change the priority levels for given data samples, data types, data sub-types, or other data characteristics.

A data node 16 provides data samples or a set of data samples from one or more data source. Each data source provides data of a particular type. Data from each data source may be associated with a particular priority level that may represent a relative importance as compared with other data items. The priority level may suitably be represented by numerical value but may be represented in other ways (e.g., alphabetical or alphanumeric characters, descriptive text strings, symbols, colors, or combinations of such).

Data samples provided from each data source may also have a sub-type, which may define some other characteristic of the data samples that are being collected. Data samples may also have other characteristics beyond the basic type and sub-type.

In a graphical data priority representation 34 according to the disclosure, a list 38 (e.g., first list 38) is presented in a first display dimension 40. The list 38 has members that represent the data samples from the data nodes 16. Members of the list 38 may include a descriptor for each individual data source, or for each individual data node 16, or members of the list 38 may include descriptors of groups of data samples. The groups may be arbitrarily defined (e.g., being groups of data sources that are in a given location or are linked to a particular function or workflow). The groups may include descriptors of data types. The list 38 may include members with a mixture of descriptors (e.g., some descriptors for specific data sources, and some descriptors for general data types).

In a graphical data priority representation 34 according to the disclosure, at least one second list 42 is displayed. The second list 42 has members that include data sample sub-types. Members of the second list(s) 42 may include a descriptor for each data sub-type and a descriptor of an associated priority level for each sub-type. The priority level may be defined as discussed above.

Normally, a separate second list 42 representing data sample sub-types will be displayed for each member of the first list 38 representing the data samples. However, there may be some members of the first list 38 for which there are no data sub-types. In this case, no separate second list 42 is displayed.

The data priority representation/data priority map (DPM) 34 of FIG. 2 represents an embodiment of the disclosure in which there are two display dimensions 40, 44. However, additional display dimensions may be added to represent alternative or additional characteristics of the data from the data nodes 16.

The data types, data priority levels, data sub-types and respective descriptors may be included in metadata in the data generated by the data nodes 16, or may be inferred from context.

The display dimensions 40, 44 of the graphical data priority representation 34 are ordered by priority level so that members of the lists 38, 42 that have the same priority levels are grouped together. This may be achieved by ordering the lists in each display dimension 40, 44 in the same sense (e.g., either all in increasing order of priority or all in decreasing order of priority), such that different portions of the displayed graphical data priority representation 34 are populated with members that have different priority levels. The different portions may be demarcated with priority boundaries 36 so that a user may easily understand how the data processing will be carried out by the data processing system 10.

In the example of FIG. 2, the two dimensions 40, 44 of the data priority representation 34 are based on inter comparison and intra comparison of industrial data.

For inter-comparison of data, certain types of data (e.g., alarms and events) may be of higher priority than the time series data (e.g., temperature values).

For intra-comparison of data, certain time series values may be collected with a higher priority with a lower sample rate, and others may be collected with a lower priority with a higher sample rate. For example, collecting temperature values every 60 seconds may be deemed as being of relatively higher priority as compared with collecting temperature values every 5 seconds. The rate of data collection is a data sub-type, with different values having different priorities.

The rows R1, R2, R3, R4 of the data priority representation 34 contain different types of industrial data like alarms & events (A&E), time series data points, and log files. The rows are used, for example, for inter-comparison of data.

Data of various types are placed in the rows in the decreasing order of priority. A&E data may, for example, be more important than time series data, followed by data from log files.

The columns C1, C2, C3, C4 of the data priority representation 34 contain different data sub-types and are arranged according to different priority levels that may correspond to different “depths” for collection of data. For example, data samples of a type of alarms and events may have data sub-types including error, warning, and information (“info”) categories. Similar sub-types may also exist for log files.

Time series data samples may be collected according to data sub-types that define different sampling rates such as once per 60 seconds (1×/60 s), 5×/60 s, etc. The columns are used, for example, for intra-comparison of data. Data of different depths are placed in the columns in the decreasing order of priorities.

In this priority map, priority boundaries 36 are defined. For example, three priority boundaries 36 are shown in the sample data priority representation 34. The priority boundaries 36 define different portions of the data priority representation 34 that represent different priority levels. A first portion includes the DPM cells {(R1, C1), (R2, C1), (R2, C2), (R3, C1)}. The data in this portion has the highest priority level and contains the A&E errors, temperature values with a sampling rate of 5× per minute, and pressure values with a sampling rate of once per hour.

Similarly, a second portion includes DPM cells {(R1, C2), (R2, C3), (R3, C2), (R4, C1)}. The data in this portion has a priority level of a second relative value and contains the A&E warnings, temperature values with a sampling rate of 10× per minute, pressure values with a sampling rate of 10x per hour, and error log files.

Similarly, a third portion includes DPM cells {(R1, C3), (R2, C4), (R3, C3), (R4, C2)}. The data in this portion has a priority level of a third relative value and contains the A&E information data, temperature values with a sampling rate of 30× per minute, pressure values with a sampling rate of 60x per hour, and error warning log files.

One example area where the present disclosure has utility is in the area of cloud platforms for the Industrial Internet of Things (IIoT). Typically, data from a device network 12 that may include industrial automation systems, machines, sensors, etc. is collected via cloud gateways 28 and sent to a remote platform 30 for storage and analysis.

The types of industrial data collected in this manner may have different priorities defined for the processing of the data. The processing includes, for example, collection of the data from data nodes 16, transmission of data to the remote platform 30 via the gateway 28, storage of the data in the remote platform 30, or analysis of the data by the remote platform 30.

There are various use cases for the prioritization of data for processing. For example: 1. Data of higher priority may be collected first from a data node 16, and the lower priority data may be collected only if the system (e.g., data node 16 along with the cloud gateway 28) performance capacity permits; 2. Data of higher priority may be transmitted to the remote platform 30 first followed by the lower priority data; 3. Data of higher priority may undergo stringent checks for error detection (e.g., cyclic redundancy checks) as compared to the data of lower priority; 4. Data of higher priority may be stored on fast and efficient storage in the cloud, while data of lower priority may be stored on alternative more cost-efficient storage; and 5. In a pricing model for cloud services, the price for collecting high priority data may be higher than that of low priority data.

Each of these use cases is improved by the present disclosure, which provides for easy and intuitive management of priority levels for controlling these parameters.

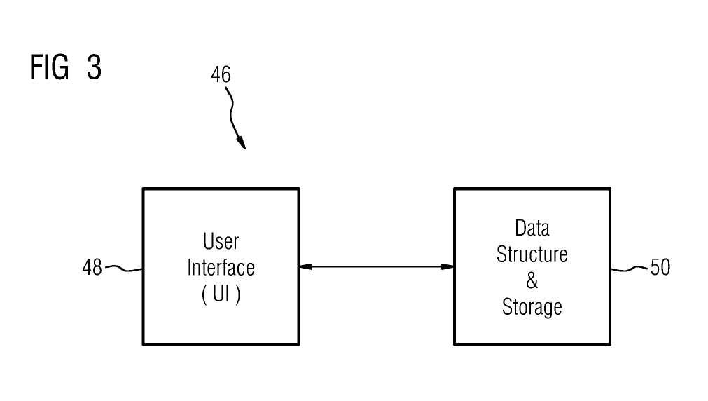

The graphical data priority representation 34 may be implemented in any computing device with a user interface (UI) or a human machine interface (HMI). FIG. 3 illustrates an implementation embodiment of a data priority representation system 46. The data priority representation system 46 includes two main components: a UI component 48 and a back-end component 50 with the appropriate data structure and data storage. The two components 48, 50 may reside on a single computing device or may be on different devices. Typically, in cloud environments, the UI 48 runs locally on a user's PC and the back-end component 50 runs in a data center.

The UI component 48 may be implemented via hypertext markup language version 5 (HTML5), the JavaScript library known as UIS, and other such technologies. The user interacts with the UI component 48 to define the inter-comparisons of data, intra-comparisons of data, and the priority boundaries 36. The user interaction may be facilitated by touch technology, pointing technology, or simply input via a keyboard.

The present embodiments may be applied to plants, plant sections (e.g., test fields), plant components (e.g., assembly lines or production lines), and plant units (e.g., pumps, squeezer, compressors or machines).

The present embodiments may be used in production industries, manufacturing industries, continuous industries, process industries, and batch processing industries.

In addition to the embodiments described above, those of skill in the art will be able to arrive at a variety of other arrangements and steps that, if not explicitly described in this document, nevertheless embody the principles of the invention and fall within the scope of the appended claims.

The present embodiments provide a graphical data priority representation 34 for the visualization and control of data processing in data processing systems 10 such as industrial Internet of things (IIoT) systems. The terms data samples, sample data, and data, as used herein, are synonyms.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method of displaying data of a data processing system, wherein the data processing system comprises a plurality of data nodes configured to provide data samples, the method comprising:
generating a graphical data priority representation, the generating of the graphical data priority representation comprising:
displaying, in a first display dimension, a first list with members representing the data samples, wherein each of the members of the first list has an associated priority level;
displaying, in a second display dimension, a second list with members comprising data sample sub-types, wherein each of the members of the second list has an associated priority level, and wherein each display dimension of the first display dimension and the second display dimension is ordered according to the priority levels associated with the members of the first list and the members of the second list, respectively; and
displaying a priority boundary demarcating different portions of the graphical data priority representation that are associated with different priority levels.

2. The method of claim 1, wherein each member of the first list represents a group of data samples, each of the groups of data samples being provided by one or more data nodes.

3. The method of claim 2, wherein one or more of the members of the first list represents a data sample type.

4. The method of claim 1, wherein the graphical data priority representation comprises one or more further display dimensions based on further characteristics of the data samples from the data nodes.

5. A method of defining priorities for data processing in a data processing system, the method comprising:
displaying data of a data processing system, wherein the data processing system comprises a plurality of data nodes configured to provide data samples, the displaying of the data comprising:
generating a graphical data priority representation, the generating of the graphical data priority representation comprising:
displaying, in a first display dimension, a first list with members representing the data samples, wherein each of the members of the first list has an associated priority level;
displaying, in a second display dimension, a second list with members comprising data sample sub-types, wherein each of the members of the second list has an associated priority level, and wherein each display dimension of the first display dimension and the second display dimension is ordered according to the priority levels associated with the members of the first list and the members of the second list, respectively; and
displaying a priority boundary demarcating different portions of the graphical data priority representation that are associated with different priority levels; and
changing the priority levels associated with members of one or more lists of the first list and the second list, the changing of the priority levels comprising re-drawing the priority boundary on the graphical data priority representation.

6. The method of claim 5, wherein re-drawing the priority boundary is performed by a user via a user interface.

7. The method of claim 5, wherein each member of the first list represents a group of data samples, each of the groups of data samples being provided by one or more data nodes.

8. The method of claim 7, wherein one or more of the members of the first list represents a data sample type.

9. The method of claim 5, wherein the graphical data priority representation comprises one or more further display dimensions based on further characteristics of the data samples from the data nodes.

10. A method of controlling data processing in a data processing system, the method comprising:
defining data priority levels for data processing in a data processing system, the defining of the data priority levels comprising:
displaying data of a data processing system, wherein the data processing system comprises a plurality of data nodes configured to provide data samples, the displaying of the data comprising:
generating a graphical data priority representation, the generating of the graphical data priority representation comprising:
displaying, in a first display dimension, a first list with members representing the data samples, wherein each of the members of the first list has an associated priority level;
displaying, in a second display dimension, a second list with members comprising data sample sub-types, wherein each of the members of the second list has an associated priority level, and wherein each display dimension of the first display dimension and the second display dimension is ordered according to the priority levels associated with the members of the first list and the members of the second list, respectively; and
displaying a priority boundary demarcating different portions of the graphical data priority representation that are associated with different priority levels; and
changing the priority levels associated with members of one or more lists of the first list and the second list, the changing of the priority levels comprising re-drawing the priority boundary on the graphical data priority representation; and
processing the data according to the defined priority levels.

11. The method of claim 10, wherein processing the data according to the defined priority levels comprises:
collecting selected data from the data nodes;
transmitting selected data from the data nodes to a remote platform;
storing selected data at a remote platform;
analyzing selected data at a remote platform; or
any combination thereof,
wherein the data is selected according to the data priority levels.

12. The method of claim 11, wherein the selection of data according to the data priority levels comprises selecting data in order of the priority levels from a highest priority level to a lowest priority level.

13. A data processing system comprising:
a plurality of data nodes configured to provide data samples
a processor configured to generate a graphical data priority representation, the generation of the graphical data priority representation comprising:
display, in a first display dimension, a first list with members representing the data samples, wherein each member of the first list has an associated priority level;
display, in a second display dimension, a second list with members comprising data sample sub-types, wherein each member of the second list has an associated priority level, and wherein each display dimension of the first display dimension and the second display dimension is ordered according to data priority levels associated with each list member; and
display a priority boundary demarcating different portions of the graphical data priority representation that are associated with different priority levels.

14. In a non-transitory computer-readable storage medium storing instructions executable by a computing device to generate a graphical data priority representation for data samples provided by a plurality of data nodes in a data processing system, the instructions comprising:
generating the graphical data priority representation, the generating of the graphical data priority representation comprising:
displaying, in a first display dimension, a first list with members representing the data samples, wherein each member of the first list has an associated priority level;
displaying, in a second display dimension, a second list with members comprising data sample sub-types, wherein each member of the second list has an associated priority level, and wherein each display dimension of the first display dimension and the second display dimension is ordered according to data priority levels associated with each list member; and
displaying a priority boundary demarcating different portions of the graphical data priority representation that are associated with different priority levels.

15. The non-transitory computer-readable storage medium of claim 14, wherein each member of the first list represents a group of data samples, each of the groups of data samples being provided by one or more data nodes.

16. The non-transitory computer-readable storage medium of claim 15, wherein one or more of the members of the first list represents a data sample type.

17. The non-transitory computer-readable storage medium of claim 14, wherein the graphical data priority representation comprises one or more further display dimensions based on further characteristics of the data samples from the data nodes.
